(19) United States
(12) Patent Application Publication
(10) Pub. No.: US 2013/0219727 A1
(43) Pub. Date: Aug. 29, 2013

(54) Three Dimensional Squaring Tool

(71) Applicant: Michael Paul Schmidt, Magnetic Island (AU)

(72) Inventor: Michael Paul Schmidt, Magnetic Island (AU)

(21) Appl. No.: 13/879,131

(22) PCT Filed: Nov. 3, 2011
(86) PCT No.: PCT/AU2011/001411

§ 371 Date: Apr. 12, 2013

(30) Foreign Application Priority Data
Nov. 3, 2010 (AU) 2010904899

(51) Int. Cl. G01B 3/56

(52) U.S. Cl. CPC G01B 3/566
USPC 33/481

(57) ABSTRACT

The invention provides squaring tool comprising at least two members operatively associated with one another to form at least a 90 degree angle, wherein each member comprises at least three arms such that the arms of each member define at least two channels along each member.

### FIELD OF THE INVENTION

The present invention relates to a hand tool for aligning at least two objects at a pre-determined angle or for checking the angle between two objects. In particular, the invention is directed to a hand tool which is a builder's square or an engineer's square, although the scope of the invention is not necessarily limited thereto.

### BACKGROUND ART

There are a number of devices available in the market which are or can be used as, squaring tools. Many of these are in the form of an L-shaped tool formed by the joining of two flat pieces of rigid material in the same plane. Additionally a number of T-shaped tools are available which are also formed by the joining of two rigid flat pieces of material in the same plane.

These devices serve their purpose as basic hand tools for aligning two objects or structures at a 90 degree angle or for checking that the angle between two objects or structures is 90 degrees, that is ‘squaring’ the two objects or structures. However, the devices are limited to uses which only require two-dimensional squaring of right-angles.

More sophisticated versions of squaring tools are available which include means for adjusting the position of one of the pieces of material which make up the tool, with respect to the other piece of material. The means for adjusting can be either in the form of a sliding mechanism or a rotating mechanism.

These devices can thus be used for aligning two objects or structures at a 90 degree angle or any other angle. The devices also have utility in checking that the angle between two objects or structures is 90 degrees, or some other required angle. However, even though these devices are more flexible than the basic tools with respect to the uses to which they can be applied, they are still limited to uses which require only two-dimensional squaring.

Therefore, there would be an advantage if it were possible to provide a squaring tool for squaring in at least three-dimensions, which may overcome the above-mentioned limitation or provide a useful or commercial choice.

It will be clearly understood that, if a prior art publication is referred to herein, this reference does not constitute an admission that the publication forms part of the common general knowledge in the art in Australia or in any other country.

### SUMMARY OF THE INVENTION

With the foregoing in view, the present invention in one form, resides broadly in a squaring tool comprising at least two members operatively associated with one another to form at least a 90 degree angle, wherein each member comprises at least three arms such that the arms of each member define at least two channels along each member.

The at least two members can be operatively associated by any suitable means. Such means can include sliding means, such that the at least two members slidably engage. In such a configuration, one of the members may slide along or relative to the other of the members.

Alternatively, the at least two members can be operatively associated by coupling pin means. In a further and preferred alternative, the at least two members can be permanently fixed together, so that there is no relative movement between the members.

Preferably, the squaring tool comprises two or three members which are operatively associated.

Each member can comprise the same number of arms, or each member can comprise different numbers of arms to the other members. In one embodiment, each member comprises three arms. The profile/cross-section of such a member would thus be hypsiloid (in the shape of a ‘Y’).

The arms typically project at equal spacings from each other. Normally a spine or similar is located at the intersection of the arms. Therefore, in those embodiments where a member has three arms, the angle between each of the arms is 120 degrees. Alternatively, the arms can project at non-equal distances or angles from each other. In such alternative embodiments, the angle between each of the arms could be any required angle (such that the sum of the angles is 360 degrees). This may require that the angle between two arms may be unusable due to its size.

In a preferred embodiment, each member comprises four arms. The arms can project at equal spacings from the member or the arms can project at non-equal spacings. The angle between each of the arms can thus be 90 degrees, so that the profile/cross-section of the member is X-shaped.

In alternative embodiments, where the four arms project at non-equal spacings from the member, the angle between each of the arms could be any required angle. For example, the four arms could define angles of 30, 60, 90 and 180 degrees.

The size of the channels along each member which are defined by the arms, are thus determined by the angle between the two arms which define a channel. The channels can be formed along the entire length of each member, or the channels can be formed along one or more portions of each member. In a preferred embodiment, the channels are continuous along the entire length of each member. It is further preferred that the channels of associated members align with one another.

Particularly preferred embodiments thus comprise two members permanently fixed to each other so that there is no relative movement between the members, each member comprising four arms projecting at equal spacings from the member, such that the inter-arm angle in each case is 90 degrees and the profile/cross-section of each member is X-shaped. The two members can be permanently fixed to each other such that the channels formed by the arms of each member are aligned.

In one such embodiment, the members having an X-shaped profile/cross-section can be permanently fixed to each other so that a channel runs along the angle formed between the members. In an alternative embodiment, the members having an X-shaped profile/cross-section can be permanently fixed to each other so that a ridge formed from an arm of each member runs along the angle formed between the members. The profile/cross-section of such embodiments is effectively a Greek cross.

The channels enable the squaring tool to be aligned on a first object, particularly a corner of a first object whilst allowing further objects to be aligned at the desired angle(s) to the first object. As an example, a channel defined by two arms which are spaced at 90 degrees, thus forming a 90 degree channel, can be positioned on an object which itself presents a 90 degree angle, such as a the edge or corner of a beam. The remaining arms and their respective channels can thus be utilised to align other objects in relation to the beam at a desired angle.

The tool can be made from any suitable material, such as metal, plastic, fibreglass or a composite material. Suitable metals include aluminium and steel. Where the tool is made from plastic, the tool can be made by any suitable means, including moulding or extrusion.

In order that the invention may be more readily understood and put into practice, a preferred embodiment thereof will now be described, by way of example only, with reference to the accompanying drawings.

### BRIEF DESCRIPTION OF THE DRAWINGS

FIG. 1 is a perspective view of a squaring tool according to an embodiment of the invention.

FIG. 2 is a view of a squaring tool according to an embodiment of the invention.

FIGS. 3 to 18 are views of the squaring tool of FIG. 2 in use in differing applications.

### DETAILED DESCRIPTION OF THE PREFERRED EMBODIMENT

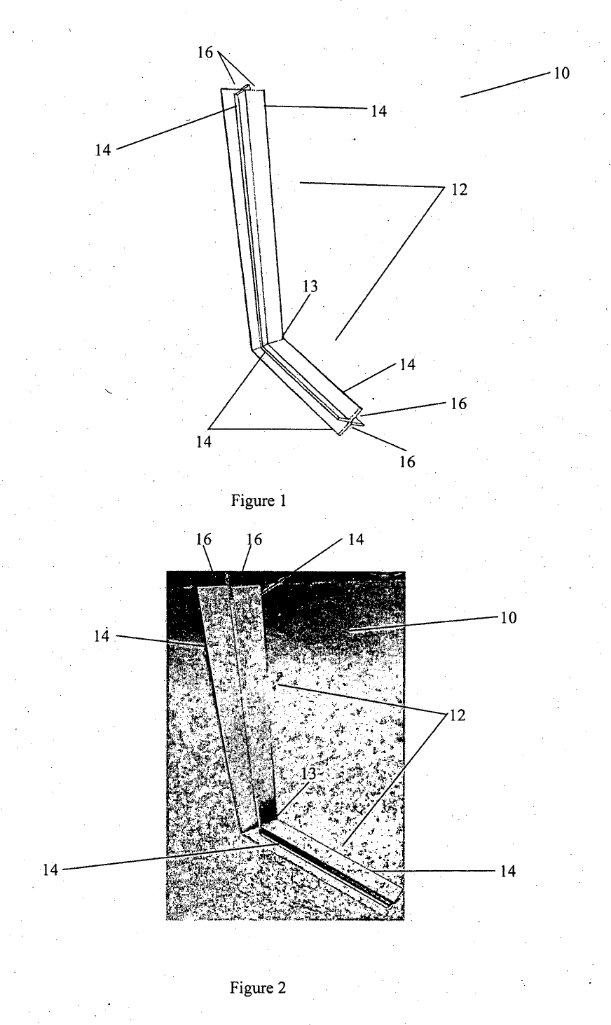

Referring to FIG. 1, there is shown a perspective view of a squaring tool 10 according to an embodiment of the invention. The squaring tool 10 comprises two members 12 which are associated such that they form a 90 degree angle 13. Each member 12 comprises four arms 14 such that the arms 14 of each member 12 define channels 16 along each member 12.

In this embodiment, the two members 12 are permanently fixed together, so that there is no relative movement between the members 12, and the arms 14 are equally spaced from the members 12 such that the angle between each arm 12 (and thus the angle of each channel 16) is 90 degrees.

FIG. 2 is a view of a squaring tool 10 according to an embodiment of the invention. Features similar to those of FIG. 1 are numbered similarly.

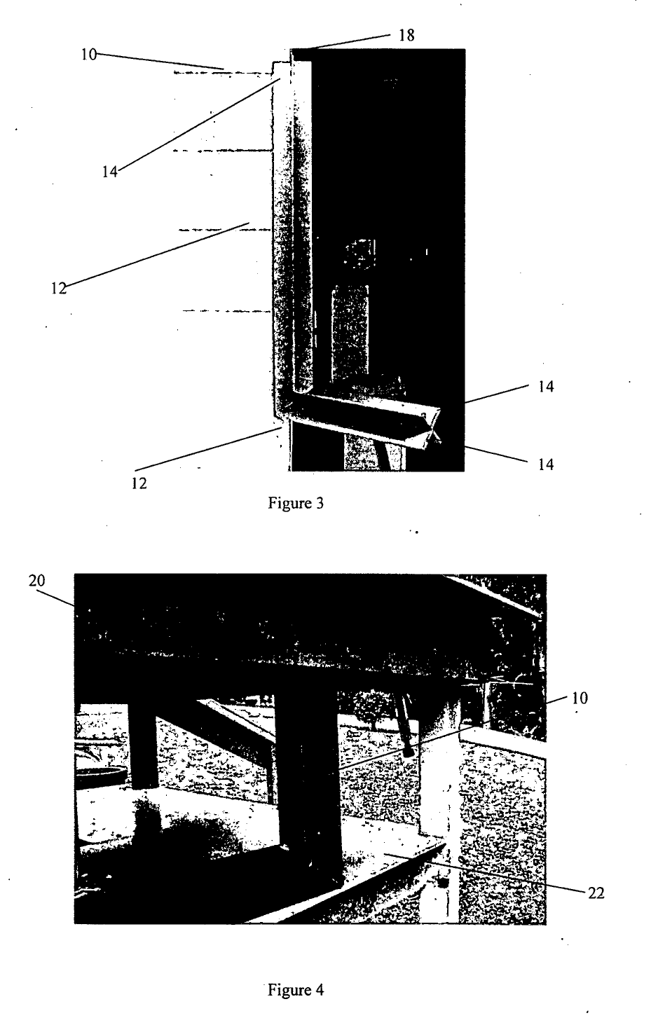

FIG. 3 is a view of the squaring tool 10 of FIG. 2 in use showing how a channel 16 having a 90 degree angle assists in positioning the tool 10 against a door opening also having a 90 degree angle. From this Figure, it can be seen how angles in multiple dimensions can be measured and/or checked from the tool 10 when so positioned.

Specifically, as shown in FIG. 3, the squaring tool 10 is positioned against a door opening using a channel 16 between two arms 14. In this embodiment, the angle of each channel 16 is 90 degrees, such that the channel 16 is complementary to the edge of the door opening, thus providing for a good fit of the squaring tool 16 on the edge of the door opening.

With the squaring tool 10 in position, the members 12, arms 14 and channels 16 enable objects to be accurately positioned at an angle or position of choice, relative to the door edge. For example, the squaring tool 10 could be used to position a beam at an angle of 45 degrees from the wall against which the tool 10 is placed by aligning the beam with the member 12 which is projecting from the wall.

In an alternative example of the use of the squaring tool 10 as shown in FIG. 3, one member 12 of the squaring tool 10 could be positioned against the door jamb 18 such that the second member 12 projects towards the far door jamb (not visible). A laser could be positioned within the channel 16 of the second member 12 and used to position an object such as a hinge or bolt on the far door jamb (not visible). Whilst positioning such an object on a far door jamb may be relatively straightforward for a standard doorway, a squaring tool 10 according to the present invention would be invaluable for a larger doorway, such as the entrance to a double garage.

FIG. 4 is a view of a squaring tool 10 of the invention showing how it can be used during activities such as building, construction and renovation. Simple placement of the tool 10 enables an upper platform 20 to be positioned equidistant from a deck 22 (that is, the planes of the platform 20 and deck 22 are parallel). Once the upper platform 20 is in place, the squaring tool 10 can also be used to position further supports for the upper platform 20.

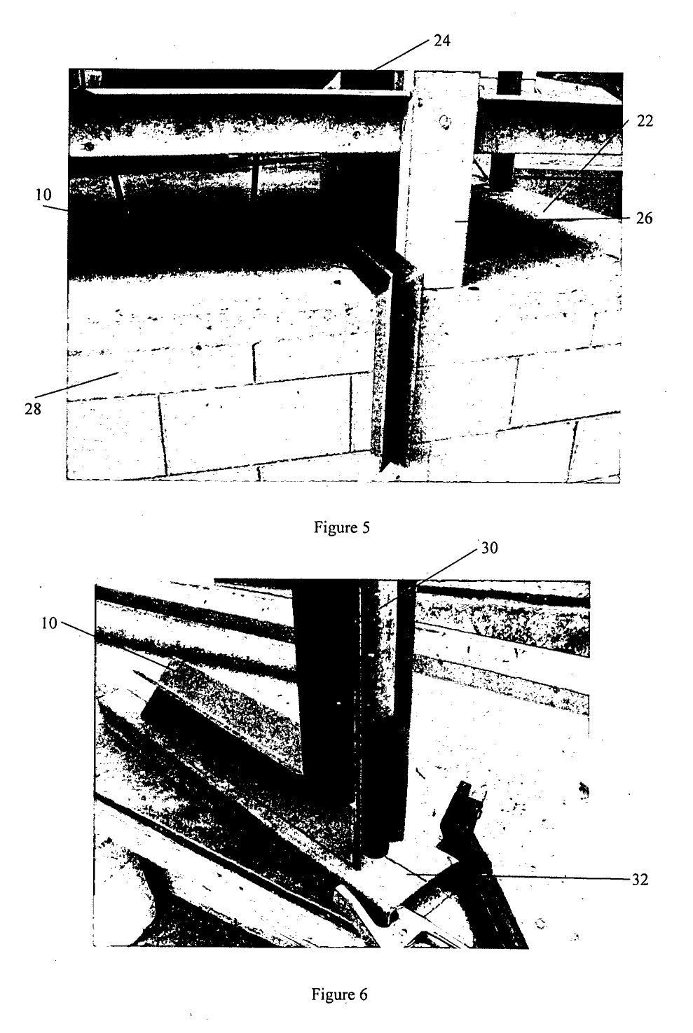

FIG. 5 is a view showing use of a squaring tool 10 of the invention, again during construction, whereby the tool 10 is used to transpose the position of a rear upright 24 so that it is square to the front upright 26 and face 28 of a deck 22.

FIG. 6 shows a squaring tool 10 of the invention in use to position a tube or pipe 30 on a piece of rectangular hollow section (RHS) 32, such as may be required for a ladder, staircase or handrail. In this use, the tool 10 allows for the tube or pipe 30 to be positioned absolutely three-dimensionally square to the RHS 32, prior to welding and therefore fixing into position, as a hands-free operation.

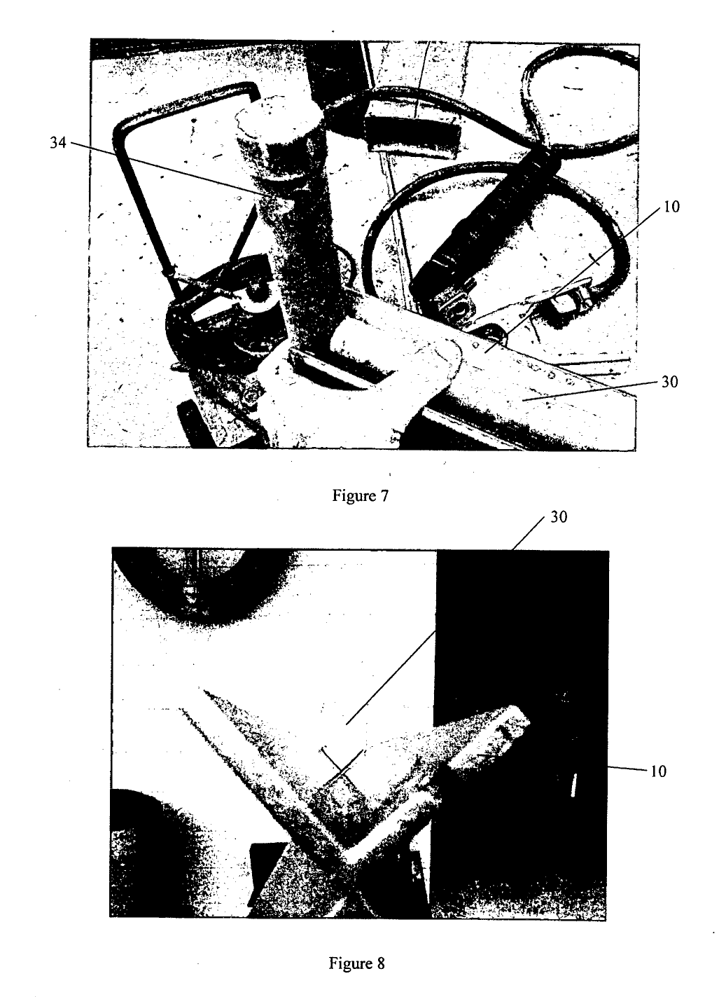

FIG. 7 shows an alternative to the use of FIG. 6, whereby the tool 10 is used to set up the position of a tube or pipe 30 (for example, for use as a rail) against a circular post 34 for welding together.

FIG. 8 shows a squaring tool 10 of the invention and how it can be used to quickly mark cutting lines on a pipe 30 for ease of mating with another piece of pipe (not shown).

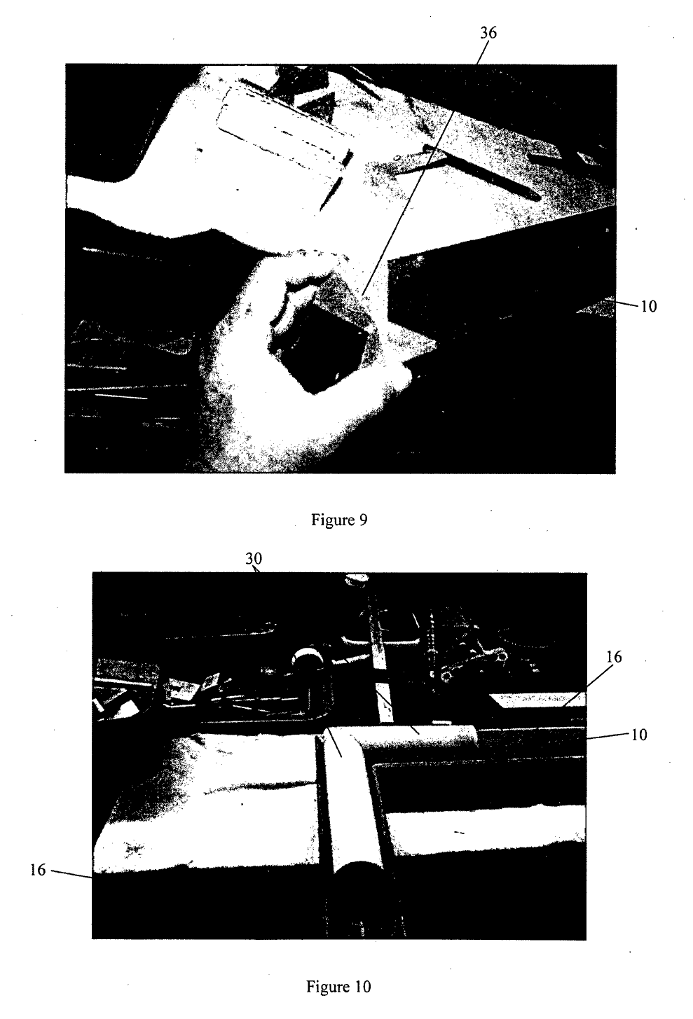

FIG. 9 shows a squaring tool 10 of the invention in use to readily set up angle iron 36 for welding.

FIG. 10 shows a squaring tool 10 of the invention in use to align two pieces of tubing 30 which have been cut to fit against each other, prior to joining the two pieces of tubing. Such an application has utility not only for building activities, but also in the area of arts and crafts. For example, by using the tool 10 in this manner, two objects can be positioned in the channels 16 of the tool 10 for gluing and left in the channels 16 to set overnight.

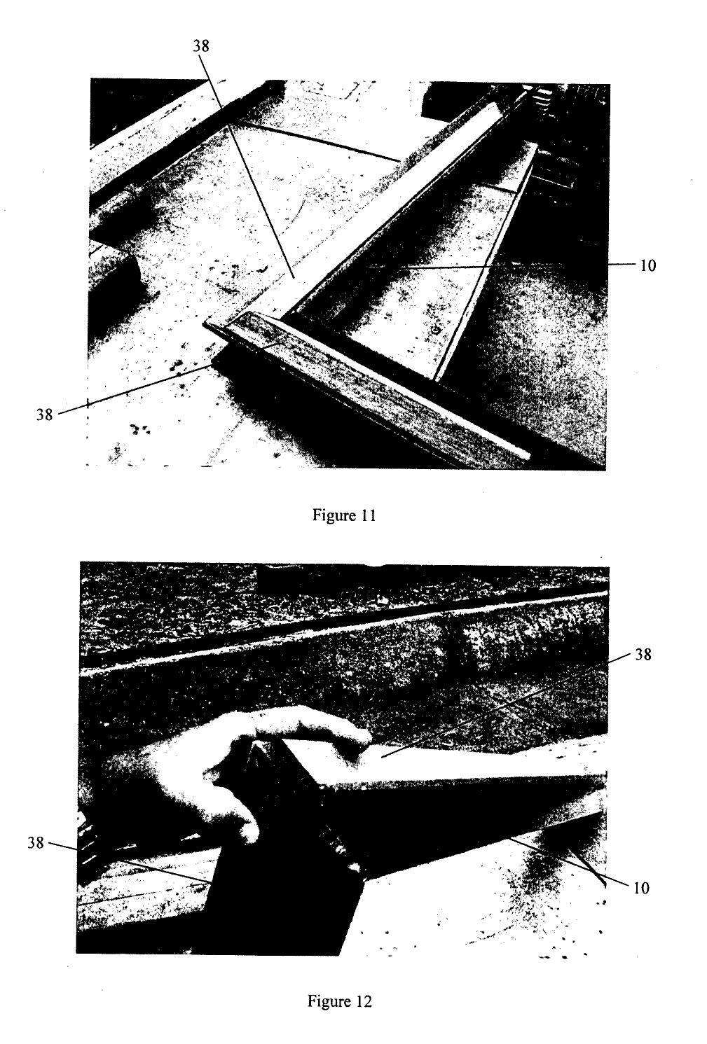

FIGS. 11 and 12 show a squaring tool 10 in use to align pieces of timber 38, for example, for making a picture frame. Again, the tool 10 can be used not only to align two objects in the required three-dimensional configuration, but to maintain the alignment during glue setting.

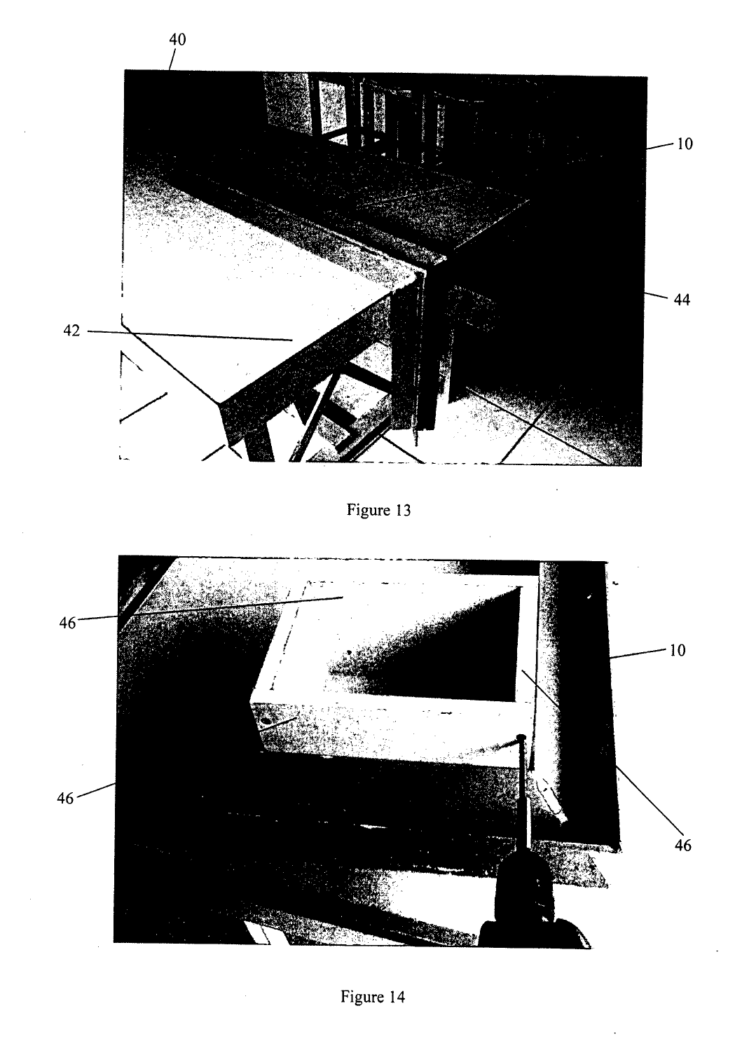

FIG. 13 provides an indication of how when a squaring tool 10 according to the invention is placed on a table 40, the top 42 and edge 44 of the table 40 can be marked in a straight line without the need to hold the squaring tool 10 in position. This allows a user to have both hands free for a job, rather than using one hand to hold a square, leaving only one hand for marking or using other tools. The squaring tool 10 is thus invaluable for assisting during assembly of objects such as flat-pack furniture (including cabinets and shelving units) to ensure everything is square.

FIG. 14 shows a squaring tool 10 in use to keep panels 46 flat and square in all planes during assembly. This is particularly useful when assembling flat pack furniture.

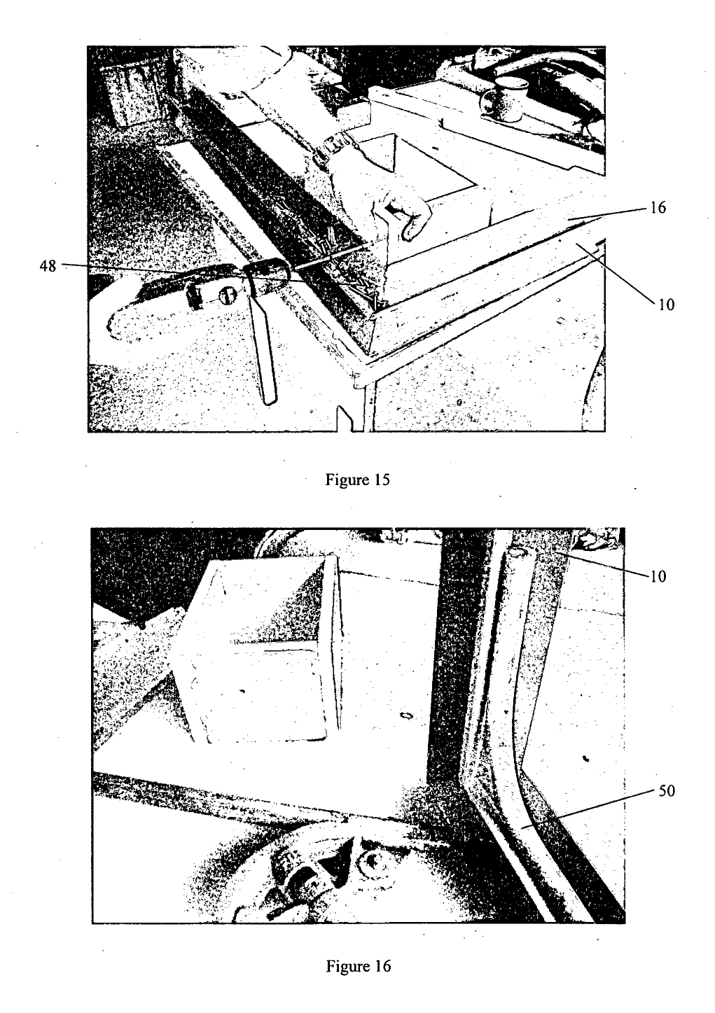

FIG. 15 shows an additional advantage of the squaring tool 10 of FIG. 14, whereby a channel 16 of the tool 10 can be used to store screws 48 (or other such items) that may be required during use of the tool 10.

FIG. 16 shows a squaring tool 10 of the invention in use to check a formed 90 degree angle in a section of plumber's pipe 50.

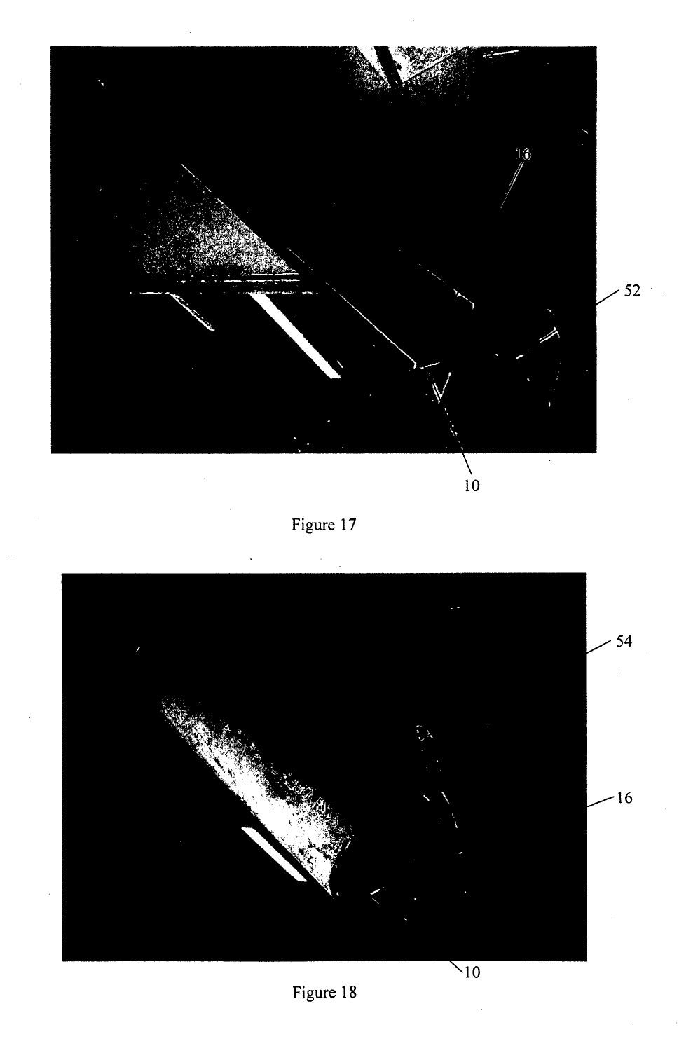

FIGS. 17 and 18 illustrate a squaring tool 10 effectively being used to steady an item such as a piece of dowel 52 or a section of polypipe 54 while the item 50 or 52 is worked on. The dowel 52 or polypipe 54 is positioned in a channel 16 of the tool 10 and the channel 16 provides a stable work environment.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

What we claim is:

1-11. (canceled)

12. A squaring tool comprising at least two members operatively associated with one another to form at least a 90 degree angle, wherein each member comprises three or four arms projecting at equal spacings such that the projecting arms of each member define three channels along each member.

13. The squaring tool of claim 12 comprising at least two members operatively associated with one another to form at least a 90 degree angle, wherein each member comprises four arms projecting at equal spacings such that the projecting arms of each member define four channels along each member.

14. The squaring tool of claim 13 wherein at least two members are permanently fixed together and do not move relative to each other.

15. The squaring tool of claim 14, comprising two members which are operatively associated with one another.

16. The squaring tool of claim 15 wherein the channels of the two members are continuous along the length of each member.

17. The squaring tool of claim 16 wherein the channels of the two members align with one another.

18. The squaring tool of claim 17, wherein the members are permanently fixed to each other such that there is a channel along the angle between the members.

19. The squaring tool of claim 17, wherein the members are permanently fixed to each other such that there is a ridge formed from an arm of each member along the angle between the members.

20. The squaring tool of claim 17, wherein the squaring tool is made from metal or plastic.

21. The squaring tool of claim 20, wherein the metal is aluminum or steel.

22. The squaring tool of claim 17, wherein the squaring tool is made from fiberglass or a composite material.

23. The squaring tool of claim 22, wherein the squaring tool is made from fiberglass.

24. The squaring tool of claim 12 wherein at least two members of the squaring tool are permanently fixed together and do not move relative to each other.

25. The squaring tool of claim 12, comprising two members which are operatively associated with one another.

26. The squaring tool of claim 13, comprising two members which are operatively associated with one another.

27. The squaring tool of claim 12, wherein the channels of the two members are continuous along the length of each member.

28. The squaring tool of claim 13, wherein the channels of the two members are continuous along the length of each member.

29. The squaring tool of claim 14, wherein the channels of the two members are continuous along the length of each member.

30. A method of aligning two objects at a pre-determined angle comprising setting the pre-determined angle of the squaring tool of claim 12 followed by the placement of one object on one member of said squaring tool and placing the other object on the other member of said squaring tool.

31. A method of determining the angle between two objects comprising the placement of one object on one member of the squaring tool of claim 12 and the other object on the other member of said squaring tool and reading the angle from said squaring tool.
